(19) United States
(12) Patent Application Publication
(10) Pub. No.: US 2006/0277041 A1
(43) Pub. Date: Dec. 7, 2006

(54) Sparse convolution of multiple vectors in a digital signal processor

(76) Inventor: Stig Stuns, Sundsvall (SE)

Correspondence Address: COOPER & DUNHAM, LLP, 1185 AVENUE OF THE AMERICAS, NEW YORK, NY, 10036, US

(21) Appl. No.: 11/145,893

(22) Filed: Jun. 6, 2005

(51) Int. Cl. G10L 19/12

(52) U.S. Cl. 704/222

(57) ABSTRACT

A method for performing convolution on one or more first vectors including multiple vector elements using one or more second vectors. The method includes identifying one or more of the multiple vector elements of the one or more first vectors that do not have a value of zero, and convoluting the one or more first vectors with the one or more second vectors for the identified one or more of the multiple vector elements of the one or more first vectors that do not have a value of zero.

### BACKGROUND

1. Technical Field

The present invention relates to convolution of multiple vectors and, more specifically, to sparse convolution of multiple vectors in a digital signal processor.

2. Description of the Related Art

Digital Signal Processing (DSP) relates to the examination and manipulation of digital representations of electronic signals. Digital signals that are processed using digital signal processing are often digital representations of real-world audio and/or video.

Digital signal processors are special-purpose microprocessors that have been optimized for the processing of digital signals. Digital signal processors are generally designed to handle digital signals in real-time, for example, by utilizing a real-time operating system (RTOS). A RTOS is an operating system that may appear to handle multiple tasks simultaneously, for example, as the tasks are received. The RTOS generally prioritizes tasks and allows for the interruption of low-priority tasks by high-priority tasks. The RTOS generally manages memory in a way that minimizes the length of time a unit of memory is locked by one particular task and minimizes the size of the unit of memory that is locked; allowing tasks to be performed asynchronously while minimizing the opportunity for multiple tasks to try to access the same block of memory at the same time.

Digital signal processors are commonly used in embedded systems. An embedded system is a specific-purpose computer that is integrated into a larger device. Embedded systems generally utilize a small-footprint RTOS that has been customized for a particular purpose. Digital signal processing is often implemented using embedded systems comprising a digital signal processor and a RTOS.

Digital signal processors are generally sophisticated devices that may include one or more microprocessors, memory banks and other electronic elements. Along with digital signal processors, embedded systems may contain additional elements such as sub-system processors/accelerators, firmware and/or other microprocessors and integrated circuits.

In processing digital signals, for example digital audio signal data, digital signal processors frequently perform functions on blocks of digital signal data called data vectors. A vector is an array of data values. A vector may be a linear array of a predetermined length. For example, a vector may be a 32 bit-long linear array, for example:

| | | | | | | | |
|---|---|---|---|---|---|---|---|
| 0001 | 1101 | 0000 | 0000 | 0000 | 1101 | 1100 | 0001 |

Alternatively, a vector may be a multi-dimensional array of a predetermined length and width. For example, a vector may be a 32 bit-long and 4 bit-wide matrix:

| | | | | | | | |
|---|---|---|---|---|---|---|---|
| 1101 | 1101 | 0010 | 0000 | 0000 | 1101 | 1100 | 0101 |
| 0001 | 1101 | 1100 | 0000 | 0000 | 0000 | 1100 | 0101 |
| 0011 | 0100 | 0000 | 0000 | 0000 | 0000 | 1100 | 1100 |
| 0001 | 1101 | 0000 | 0000 | 0000 | 1101 | 1100 | 1111 |

Multi-dimensional data vectors may be used, for example, to represent multi-channel digital audio signals.

Use of vectors may allow for the simultaneous processing of large blocks of data. This may be especially useful when performing multiple functions on the same data vector and/or the same functions(s) are performed on multiple data vectors, as is frequently the case with digital signal processing.

Coefficient vectors (tap vectors) are vectors that may be used to process data vectors. For example, one or more coefficient vector may be convoluted with one or more data vectors. Convolution is a mathematical operation wherein multiple vectors may be merged to produce a vector that is the overlap of the multiple vectors. Convolution is defined by the equation:
f(t)=h(t)\textcircled{x}g(t)=∫h(τ)g(t−τ)dτ

Where f(t) is defined as the convoluted vector, h(t) and g(t) are the multiple vectors to be convoluted. For discrete vectors, such as vectors processed by digital signal processors, convolution may be expressed by the equation:

$$f ( t ) = h ( t ) ⊗ g ( t ) = {\sum }_{n} h ( n ) g ( t - n )$$

For linear vectors h and g of a predetermined length N, convolution may be more simply expressed by the equation:

$$f = h ⊗ g = {\sum }_{i = 0}^{i < N} h ( i ) g ( i )$$

As is often the case with digital signal processing, a single data vector may be convoluted with multiple coefficient vectors. Where g(j)(i) represents multiple coefficient vectors i.e. g1(i), g2(i), g3(i), . . . , gK(i), convolution may be expressed by the equation:

$$f = h ⊗ g = {\sum }_{j = o}^{j < K} {\sum }_{i = 0}^{i < N} h ( i ) g ( j ) ( i )$$

Code for calculating the convolution of data vector h and K coefficient vectors g of a predetermined length N may be:

for (k=0;k<K;k++) {
sum=0;
for (i=0;i<N;i++)

sum = sum + VecH[i] * VecG[k][i];

}

When the above code is executed on a digital signal processor, for example a one-mac DSP, approximately K*N processing cycles may be required to calculate the convolution. Additional cycles and/or instructions may be required as overhead for setting up addresses, pointers and loop registers.

In a typical DSP, calculating the convolution, for example, using code such as the code above, may require execution of one or more steps for each processing cycle. For example steps may be taken during each processing cycle to calculate the convolution for a data vector (VecH) and multiple coefficient Vectors (VecG). In this example, VecH is stored in a memory X, with each element of VecH pointed to by a pointer x_ptr and having a value x_oper. VecG is stored in a memory Y, with each element of VecG pointed to by a pointer y_ptr and having a value y_oper. First, the VecH element x_oper for the current value of i may be fetched from memory X using appropriate memory pointers, for example x_ptr. The VecG element y_oper for the current value of i may be fetched from memory Y using appropriate memory pointers, for example y_ptr. The pointer x_ptr may be advanced by one register step, for example x_ptr=x_ptr+x_step where x_step is a single register. By advancing the pointer x_ptr by one register step, every register step is used in convolution. The pointer y_ptr may be advanced by one register step, for example y_ptr=y_ptr+y_step where y_step is a single register. The product of x_oper and y_oper may be calculated, for example prod=x_oper*y_oper. The accumulated result may be increased by the product of x_oper and y_oper, for example acr=acr+prod, where acr is the accumulator result register.

As can be seen by the above steps, calculating the convolution of multiple vectors can be an intensive and demanding endeavor. This may be especially true where there are a large number of coefficient vectors that are all convoluted with the same data vector.

It is therefore desirable to utilize a more efficient method and/or system for convoluting multiple vectors, for example in a digital signal processor. By utilizing a more efficient method and/or system, performance of the digital signal processor may be enhanced.

### SUMMARY

A method for performing convolution on one or more first vectors including multiple vector elements using one or more second vectors. The method includes identifying one or more of the multiple vector elements of the one or more first vectors that do not have a value of zero, and convoluting the one or more first vectors with the one or more second vectors for the identified one or more of the multiple vector elements of the one or more first vectors that do not have a value of zero.

A system for performing convolution on one or more first vectors including multiple vector elements using one or more second vectors. The system includes an identifying unit for identifying one or more of the multiple vector elements of the one or more first vectors that do not have a value of zero and a convoluting unit for convoluting the one or more first vectors with the one or more second vectors for the identified one or more of the multiple vector elements of the one or more first vectors that do not have a value of zero.

A computer system includes a processor and a program storage device readable by the computer system, embodying a program of instructions executable by the processor to perform method steps for performing convolution on one or more first vectors including multiple vector elements using one or more second vectors. The method includes identifying one or more of the multiple vector elements of the one or more first vectors that do not have a value of zero and convoluting the one or more first vectors with the one or more second vectors for the identified one or more of the multiple vector elements of the one or more first vectors that do not have a value of zero.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a flow chart showing a method for sparse convolution according to an embodiment of the present invention;

FIG. 2A is a block diagram illustrating a system for performing convolution according to an embodiment of the present disclosure;

FIG. 2B is a block diagram illustrating a system for performing convolution according to another embodiment of the present disclosure;

FIG. 2C is a block diagram illustrating a system for performing convolution according to another embodiment of the present disclosure;

FIG. 2D is a block diagram illustrating a system for performing convolution according to another embodiment of the present disclosure;

FIG. 2E is a block diagram illustrating a system for performing convolution according to another embodiment of the present disclosure; and

FIG. 3 is a block diagram showing an example of a computer system which may implement the method and system of the present invention.

### DETAILED DESCRIPTION

In describing the preferred embodiments of the present invention illustrated in the drawings, specific terminology is employed for sake of clarity. However, the present invention is not intended to be limited to the specific terminology so selected, and it is to be understood that each specific element includes all technical equivalents which operate in a similar manner.

Vectors may contain clusters of zeroes. This may be especially true of data vectors representing video and/or audio signals. In calculating convolution, clusters of zeroes within vectors may result in multiple processing cycles with multiple processing steps that do not contribute to the accumulating of the convolution result. Embodiments of the present invention therefore seek to avoid processing steps by avoiding processing cycles where one or more of the vector elements are identified as having a value of zero.

According to one embodiment of the present invention, a convolution may be calculated for one or more coefficient vectors and one or more data vector while omitting processing cycles and/or steps where one or more of the vector elements that are used to calculate a product have a value of zero. Convolution omitting these cycles and/or steps may be referred to as sparse convolution.

Sparse convolution may reduce the number of cycles and/or steps (calculations) that are required to calculate a convolution. As a result, digital signal processors that may be able to process data at a maximum number of millions of instructions per second (mips) will be able to have an effectively increased computing power as fewer instructions are required to process convolution. Moreover, sparse convolution may allow digital signal processor manufacturers to use less expensive digital signal processors to perform the same result while potentially using less electrical power.

An example of code for calculating the convolution of a data vector h and K coefficient vectors g of a predetermined length N (where M equals the predetermined length N minus the number of zeroes that occur in the data vectors h according to an embodiment of the present invention may be:

for (k=0;k<K;k++) {
sum=j=0;
for (i=0;i<M;i++) {

j=j+StepVec[i]
sum = sum + VecH[j] * VecG[k][j];

}
}

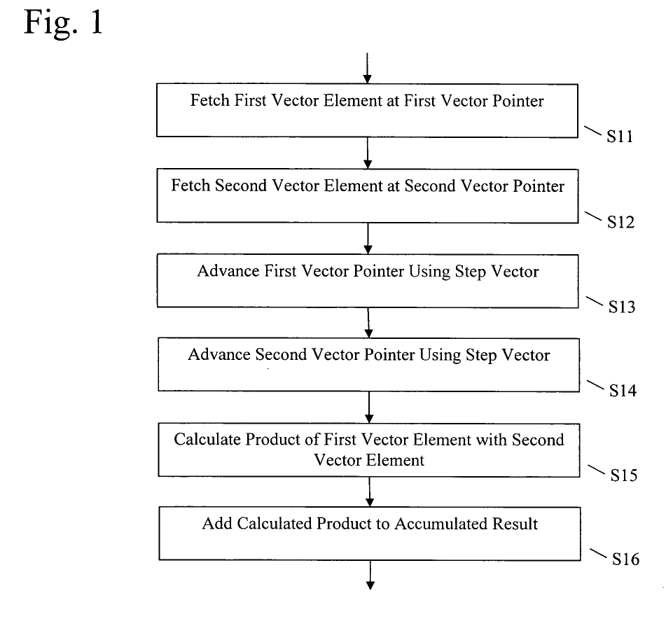

FIG. 1 is a flow chart showing a method for sparse convolution according to an embodiment of the present invention. In this example, a data vector (VecH) and multiple coefficient Vectors (VecG) are convoluted. VecH is stored in a memory X, with each element of VecH pointed to by a pointer x_ptr and having a value x_oper. The multiple vectors VecG are stored in a memory Y, with each element of each vector pointed to by a pointer y_ptr and having a value y_oper.

First, the VecH element x_oper for the current value of j may be fetched from memory X using appropriate memory pointers, for example x_ptr (Step S11). The VecG element y_oper for the current value of j may be fetched from memory Y using appropriate memory pointers, for example y_ptr (Step S12). The pointer x_ptr may be advanced by a number of register steps determined by a step vector function StepVec[i]. For example x_ptr=x_ptr+StepVec[i] where StepVec[i] dictates when and how many register steps need be advanced to skip any elements with zero values within the VecH data vector (Step S13). By advancing the pointer x_ptr by StepVec[i] register steps, every register step need not be used in convolution and calculations may be avoided. The pointer y_ptr may be advanced in the same way as the x_ptr, for example y_ptr=y_ptr+StepVec[i] (Step S14). The product of x_oper and y_oper may be calculated, for example prod=x_oper*y_oper (Step S15). The accumulated result may be increased by the product of x_oper and y_oper, for example acr=acr+prod, where acr is the accumulator result register (Step S16).

As indicated above, the step vector function StepVec[i] provides the number of register steps to advance the value of j such that each element of the data vector VecH(j) does not equal zero. By advancing the pointers using the step vector, rather than advancing the pointers by one register at a time, the values of VecH that equal zero may be skipped. By skipping the values of VecH that equal zero, one or more values of both VecH (the data vector) and VecG (the multiple coefficient vectors) need not be located, read from memory and used to contribute to the convolution calculation. In this way, multiple processing steps may be avoided. For example, the number of memory accesses would decrease from 2*K*N to 2*K*M where M=N−(the number of zero values within VecH).

For example, where VecH is the vector:

| VecH | VecH | VecH | VecH | VecH | VecH | VecH | VecH |
|---|---|---|---|---|---|---|---|
| [0] | [1] | [2] | [3] | [4] | [5] | [6] | [7] |
| 0001 | 1101 | 0000 | 0000 | 0000 | 1101 | 1100 | 0001 |

StepVec[i] may be:

| Step | Step | Step | Step |
|---|---|---|---|
| Vec | Vec | Vec | Vec |
| [0] | [1] | [2] | [3] |
| 1 | 4 | 1 | 1 |

Such that in calculating the convolution of VecH and VecG, VecH[j=0]=0001 may be utilized (multiplied by VecG[k][j] with the product added to the accumulating convolution result). Then j is incremented by the value of StepVec[i=0]=1 such that the new value of j is 1. Next VecH[j=1]=1101 may be utilized. Then j may be incremented by the value of StepVec[i=1]=4 such that the new value of j is 5. Next VecH[j=5]=1101 may be utilized. Then j is incremented by the value of StepVec[i=2]=1, such that the new value of j is 6. Next VecH[j=6]=1100 may be utilized. Then j is incremented by the value of StepVec[i=3]=1 such that the new value of j is 7. Lastly VecH[j=7]=0001 may be utilized. Therefore, in this example, five elements of VecH were utilized instead of all eight.

The StepVec step vector may be generated by the digital signal processor, for example, before implementing a convolution loop. The StepVec step vector may be generated, for example, by examining the elements of the data vector to identify what stepping increments would be required to step past one or more elements of the data vector with zero values. The generation of the StepVec step vector may be part of the additional overhead used to implement embodiments of the present invention.

The StepVec step vector, for example, may be a 4-bit array such that each element of the StepVec vector is a 4-bit word that can indicate the proper number of registers to increment, for example, by indicating how many register elements separate each vector register element that does not have a value of zero. Where each element of the StepVec step vector is a 4-bit word, each element may have a value between 1 and 16. Thus the largest number of zero-valued elements that may be skipped is 15. Alternatively, the StepVec step vector may be an array of larger words to allow for larger blocks of element skipping.

The StepVec may be generated by the digital signal processor as part of an address generator (AG). The AG may be used to generate addresses utilized by the digital signal processor. The AG may be implemented as a register bank.

Because embodiments of the present invention may utilize additional overhead, for example, to generate the StepVec step vector and M (the number of non-zero valued elements within the data vector), the benefits of the present invention may increase as more coefficient vectors are used to convolute the same data vector(s). Therefore, some embodiments of the present invention may utilize standard convolution when there are a relatively small number of coefficient vectors and utilize sparse convolution when there are a relatively large number of coefficient vectors. For example, standard convolution may be used when there is only a single coefficient vector while sparse convolution may be used when there are multiple coefficient vectors.

According to another embodiment of the present invention, convolution may be performed using one or more coefficient vectors comprising multiple vector elements using one or more data vectors. Such embodiments may comprise identifying one or more of the multiple vector elements of the one or more coefficient vectors that do not have a value of zero and convoluting the one or more coefficient vectors with the one or more data vectors for the identified one or more of the multiple vector elements of the single coefficient vector that do not have a value of zero.

In such an embodiment, the coefficient vector may be parsed for identifying zeroes in a manner similar to the way the data vector may be parsed for identifying zeroes as described in the prior embodiments above.

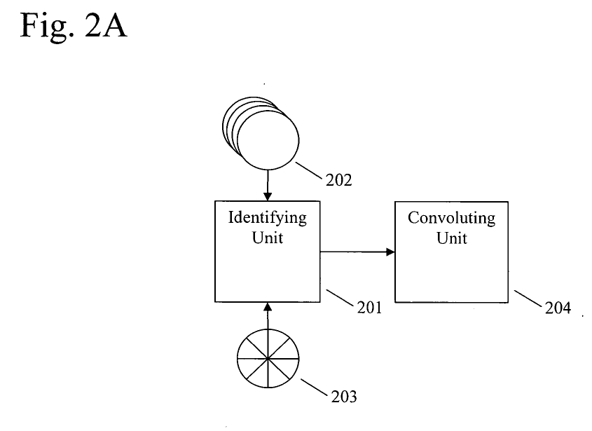

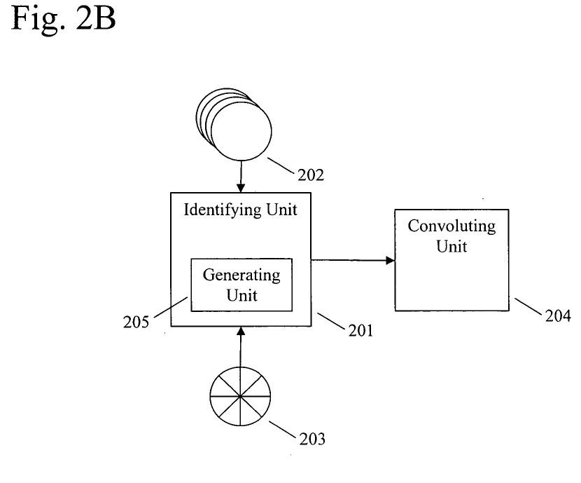

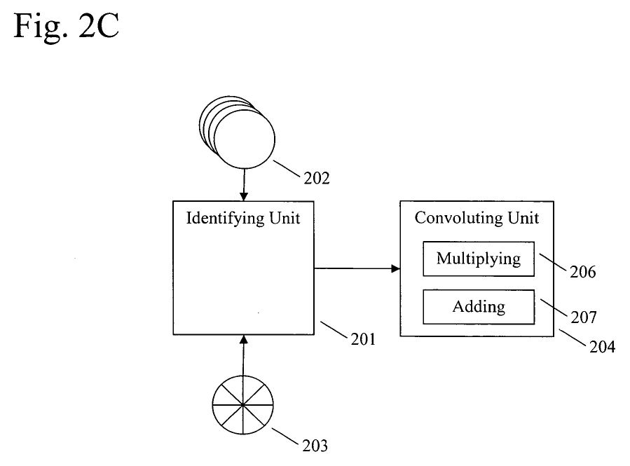

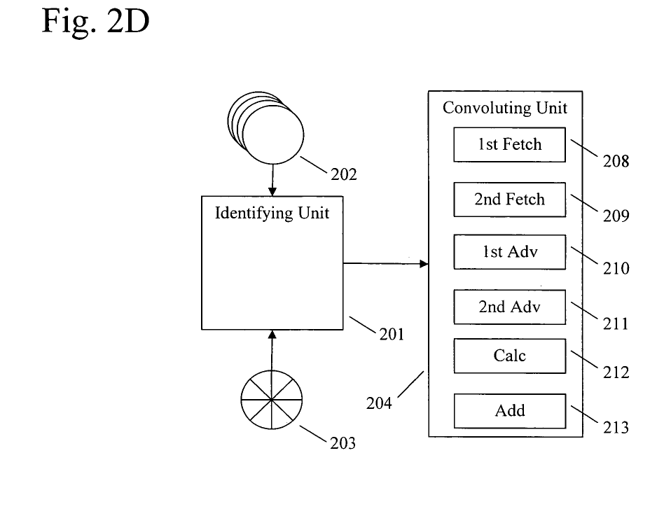

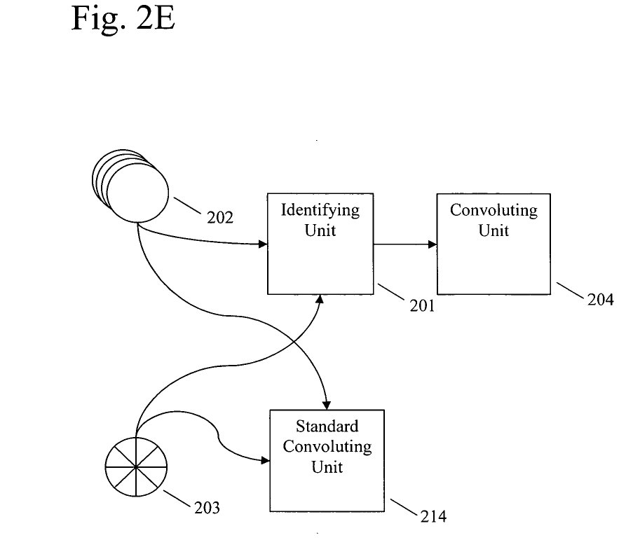

FIG. 2A is a block diagram illustrating a system for performing convolution according to an embodiment of the present disclosure. In this embodiment of the present disclosure, convolution may be performed on one or more first vectors (203) including multiple vector elements using one or more second vectors (202) (FIGS. 2A-2E show, as examples, embodiments where there are a plurality of second vectors and there is a single first vector). An identifying unit (201) may be provided for identifying one or more of the multiple vector elements of the one or more first vectors (203) that do not have a value of zero. A convoluting unit (204) may be provided for convoluting the one or more first vectors (203) with the one or more second vectors (202) for the identified one or more of the multiple vector elements of the one or more first vectors (203) that do not have a value of zero.

FIG. 2B is a block diagram illustrating a system for performing convolution according to another embodiment of the present disclosure. In this embodiment, the identifying unit (201) may include a generating unit (205) for generating a step vector that may indicate how many elements separate each of the one or more of the multiple vector elements of the one or more first vectors (203) that do not have a value of zero.

FIG. 2C is a block diagram illustrating a system for performing convolution according to another embodiment of the present disclosure. In this embodiment, the convoluting unit (204) may include a multiplying unit (206) for multiplying each of the multiple elements of the one or more first vectors (203) that do not have a value of zero with the one or more second vectors (202) to form multiple products. The convoluting unit (204) may additionally include an adding unit (207) for adding the products to an accumulator.

FIG. 2D is a block diagram illustrating a system for performing convolution according to another embodiment of the present disclosure. In this embodiment, the convoluting unit (204) may include a first-fetching unit (208) for fetching a first vector element at a first vector pointer. The convoluting unit (204) may also include a second-fetching unit (209) for fetching a second vector element at a second vector pointer. The convoluting unit (204) may also include a first-advancing unit (210) for advancing the first vector pointer using a step vector. The convoluting unit (204) may also include a second-advancing unit (211) for advancing the second vector pointer using the step vector. The convoluting unit (204) may also include a calculating unit (212) for calculating a product of the first vector element with the second vector element. The convoluting unit (204) may also include an adding unit (213) for adding the product to an accumulated result. The step vector may indicate how many elements separate each of the one or more of the multiple vector elements of the one or more first vectors that do not have a value of zero.

FIG. 2E is a block diagram illustrating a system for performing convolution according to another embodiment of the present disclosure. In this embodiment, the identifying unit (201) and the convoluting unit (204) may be active, for example utilized, when there are a relatively large number of second vectors (202). A standard-convoluting unit (214) may additionally be included for convoluting the one or more first vectors (203) with the one or more second vectors (202) for all of the multiple vector elements of the one or more first vectors when there is a relatively small number of second vectors.

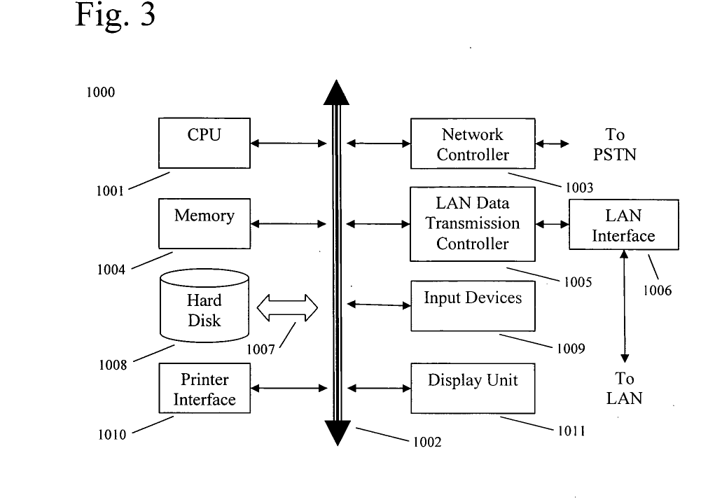

FIG. 3 is a block diagram showing an example of a computer system which may implement the method and system of the present invention. The system and method of the present invention may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The above specific embodiments are illustrative, and many variations can be introduced on these embodiments without departing from the spirit of the invention or from the scope of the appended claims. For example, elements and/or features of different illustrative embodiments may be combined with each other and/or substituted for each other within the scope of this invention and appended claims.

What is claimed is:

1. A method for performing convolution on one or more first vectors comprising multiple vector elements using one or more second vectors, the method comprising:
identifying one or more of the multiple vector elements of the one or more first vectors that do not have a value of zero; and
convoluting the one or more first vectors with the one or more second vectors for the identified one or more of the multiple vector elements of the one or more first vectors that do not have a value of zero.

2. The method of claim 1, wherein the one or more first vectors are one or more data vectors and the one or more second vectors are one or more coefficient vectors

3. The method of claim 1, wherein the one or more first vectors are one or more coefficient vectors and the one or more second vectors are one or more data vectors.

4. The method of claim 1, wherein the step of identifying the one or more of the multiple vector elements of the one or more first vectors that do not have a value of zero comprises generating a step vector that indicates how many elements separate each of the one or more of the multiple vector elements of the one or more first vectors that do not have a value of zero.

5. The method of claim 1, wherein the step of convoluting the one or more first vectors with the one or more second vectors for the elements of the one or more first vectors that do not have values of zero comprises:
multiplying each of the multiple elements of the one or more first vectors that do not have a value of zero with the one or more second vectors to form multiple products; and
adding the products to an accumulator.

6. The method of claim 1, wherein the step of convoluting the one or more first vectors with the one or more second vectors for the elements of the one or more first vectors that do not have values of zero comprises:
fetching a first vector element at a first vector pointer;
fetching a second vector element at a second vector pointer;
advancing the first vector pointer using a step vector;
advancing the second vector pointer using the step vector;
calculating a product of the first vector element with the second vector element; and
adding the product to an accumulated result, wherein the step vector indicates how many elements separate each of the one or more of the multiple vector elements of the one or more first vectors that do not have a value of zero.

7. The method of claim 6, wherein the step of convoluting the one or more first vectors with the one or more second vectors for the elements of the one or more first vectors that do not have values of zero is repeated until the product is added to the accumulated result for each of the one or more of the multiple vector elements of the one or more first vectors that do not have a value of zero and for each second vector.

8. The method of claim 1, wherein the steps of:
identifying one or more of the multiple vector elements of the one or more first vectors that do not have a value of zero; and
convoluting the one or more first vectors with the one or more second vectors for the identified one or more of the multiple vector elements of the one or more first vectors that do not have a value of zero,
are performed when there is a relatively large number of second vectors, and the step of:
convoluting the one or more first vectors with the one or more second vectors for all of the multiple vector elements of the one or more first vectors,
is performed when there are a relatively small number of second vectors.

9. The method of claim 8, wherein the relatively small number of second vectors comprises only a single second vector and the relatively large number of second vectors comprises more than a single second vector.

10. A system for performing convolution on one or more first vectors comprising multiple vector elements using one or more second vectors, comprising:
an identifying unit for identifying one or more of the multiple vector elements of the one or more first vectors that do not have a value of zero; and
a convoluting unit for convoluting the one or more first vectors with the one or more second vectors for the identified one or more of the multiple vector elements of the one or more first vectors that do not have a value of zero.

11. The system of claim 10, wherein the one or more first vectors are one or more data vectors and the one or more second vectors are one or more coefficient vectors.

12. The system of claim 10, wherein the one or more first vectors are one or more coefficient vectors and the one or more second vectors are one or more data vectors.

13. The system of claim 10, wherein the identifying unit comprises a generating unit for generating a step vector that indicates how many elements separate each of the one or more of the multiple vector elements of the one or more first vectors that do not have a value of zero.

14. The system of claim 10, wherein the convoluting unit comprises:
a multiplying unit for multiplying each of the multiple elements of the one or more first vectors that do not have a value of zero with the one or more second vectors to form multiple products; and
an adding unit for adding the products to an accumulator.

15. The system of claim 10, wherein the convoluting unit comprises:
a first-fetching unit for fetching a first vector element at a first vector pointer;
a second-fetching unit for fetching a second vector element at a second vector pointer;
a first-advancing unit for advancing the first vector pointer using a step vector;
a second-advancing unit for advancing the second vector pointer using the step vector;
a calculating unit for calculating a product of the first vector element with the second vector element; and
an adding unit for adding the product to an accumulated result, wherein the step vector indicates how many elements separate each of the one or more of the multiple vector elements of the one or more first vectors that do not have a value of zero.

16. The system of claim 15, wherein the convoluting unit convolutes the one or more first vectors with the one or more second vectors for the elements of the one or more first vectors that do not have values of zero repeatedly until the product is added to the accumulated result for each of the one or more of the multiple vector elements of the one or more first vectors that do not have a value of zero and for each second vector.

17. The system of claim 10, wherein the identifying unit and the convoluting unit are active when there is a relatively large number of second vectors, and wherein the system additionally comprises:
a standard-convoluting unit for convoluting the one or more first vectors with the one or more second vectors for all of the multiple vector elements of the one or more first vectors,
and the standard-convoluting unit is active when there are a relatively small number of second vectors.

18. The system of claim 17, wherein the relatively small number of second vectors comprises only a single second vector and the relatively large number of second vectors comprises more than a single second vector.

19. A computer system comprising:
a processor; and
a program storage device readable by the computer system, embodying a program of instructions executable by the processor to perform method steps for performing convolution on one or more first vectors comprising multiple vector elements using one or more second vectors, the method comprising:
identifying one or more of the multiple vector elements of the one or more first vectors that do not have a value of zero; and
convoluting the one or more first vectors with the one or more second vectors for the identified one or more of the multiple vector elements of the one or more first vectors that do not have a value of zero.

20. The computer system of claim 19, wherein the one or more first vectors are one or more data vectors and the one or more second vectors are one or more coefficient vectors.

21. The computer system of claim 19, wherein the one or more first vectors are one or more coefficient vectors and the one or more second vectors are one or more data vectors.

22. The computer system of claim 19, wherein the step of identifying the one or more of the multiple vector elements of the one or more first vectors that do not have a value of zero comprises generating a step vector that indicates how many elements separate each of the one or more of the multiple vector elements of the one or more first vectors that do not have a value of zero.
